(19) United States
(12) Patent Application Publication
(10) Pub. No.: US 2026/0167233 A1
(43) Pub. Date: Jun. 18, 2026

(54) METHOD AND APPARATUS FOR PREDICTING A PATH OF A TARGET

(71) Applicants: HYUNDAI MOTOR COMPANY, Seoul (KR); KIA CORPORATION, Seoul (KR)

(72) Inventor: Sung Wook Lee, Hwaseong-si (KR)

(73) Assignees: HYUNDAI MOTOR COMPANY, Seoul (KR); KIA CORPORATION, Seoul (KR)

(21) Appl. No.: 19/336,438

(22) Filed: Sep. 22, 2025

(30) Foreign Application Priority Data
Dec. 18, 2024 (KR) 10-2024-0190079

(51) Int. Cl. B60W 60/00; B60W 40/105; B60W 40/114

(52) U.S. Cl. CPC B60W 60/00272; B60W 40/105; B60W 40/114; B60W 2520/10; B60W 2520/14; B60W 2530/201; B60W 2540/18; B60W 2554/4042; B60W 2554/4044; B60W 2554/801

(57) ABSTRACT

A method for predicting a driving path of a target includes receiving driving information of an ego vehicle and the target. The method further includes determining whether the target is driving relative to a path of the ego vehicle, based on the driving information of the ego vehicle and the target. The method further includes determining a turning radius of the ego vehicle based on the driving information of the ego vehicle. The method further includes determining a turning radius of the target based on the turning radius of the ego vehicle. The method further includes generating a yaw rate profile of the target based on the turning radius of the target. The method further includes predicting a path of the target based on the yaw rate profile of the target.

### CROSS-REFERENCE TO RELATED APPLICATION

This application claims the benefit of and priority to Korean Patent Application No. 10-2024-0190079, filed on Dec. 18, 2024 in the Korea Intellectual Property Office, the entire contents of which are incorporated herein by reference.

### TECHNICAL FIELD

The present disclosure relates to a method and an apparatus for predicting a path of a target. More particularly, the present disclosure relates to a method and an apparatus for improving path prediction accuracy by using driving information of an ego vehicle, particularly a turning radius of the ego vehicle, when predicting a path of a target in a situation where the ego vehicle may not obtain map information and/or lane information.

### BACKGROUND

The matters described in this Background section are only for enhancement of understanding of the background of the disclosure, and should not be taken as acknowledgement that they correspond to prior art already known to those having ordinary skill in the art.

An autonomous vehicle needs to predict the future path of an object (target) around the autonomous vehicle for path planning, a collision avoidance decision, etc. For example, when there is an object such as other vehicles, pedestrians, and personal mobility devices around the autonomous vehicle, the autonomous vehicle should predict the future path of the target and should warn a driver or take evasive action before a collision occurs.

The related art utilizes the target's driving information (velocity, direction, position, etc.) and map information or lane information to predict the driving path of a target vehicle driving on a road. Because the target driving on the road generally drives along a lane, the related art predicts the target's driving path based on map information or lane information of an area in which the ego vehicle and the target are driving.

However, the related art has limitations in that it is difficult to accurately predict the target's driving path when the map information or the lane information may not be utilized. If the target's yaw rate on a curved road, an intersection, etc. is ignored and it is assumed that the target is driving straight in a current driving direction, the predicted path deviates significantly from the target's actual future path. Among conventional technologies, there is a technology that generates turning information based on the amount of change in the heading angle of the target and predicts the driving path of the target. However, this is problematic in that a target heading angle error caused by sensor recognition error is large, leading to significant distortion in a turning amount.

Therefore, a technology is needed that can accurately predict the target's driving path even when map information and lane information are unavailable or inaccurate (e.g., past map information, rainy conditions where it is difficult for a sensor to recognize a lane, etc.).

### SUMMARY

In view of the above, the present disclosure provides a method and an apparatus for improving path prediction accuracy by predicting the driving path of a target based on driving information of an ego vehicle, even when map information and lane information are not available when predicting the path of the target.

The present disclosure provides a method and an apparatus capable of providing information on whether a target overlaps with the driving path of an ego vehicle.

Technical objects to be achieved by the present disclosure are not limited to those described above, and other technical objects not mentioned above may also be clearly understood from the present disclosure by those having ordinary skill in the art to which the present disclosure belongs.

An embodiment of the present disclosure provides a method for predicting a driving path of a target. The method includes receiving driving information of an ego vehicle and the target. The method further includes determining whether the target is driving relative to a path of the ego vehicle based on the driving information of the ego vehicle and the target. The method further includes calculating or determining a turning radius of the ego vehicle based on the driving information of the ego vehicle. The method further includes calculating or determining a turning radius of the target based on the turning radius of the ego vehicle. The method further includes generating a yaw rate profile of the target based on the turning radius of the target. The method further includes predicting a path of the target based on the yaw rate profile of the target.

Another embodiment of the present disclosure provides an apparatus including at least one memory configured to store commands; and at least one processor. The at least one processor is configured, by executing the commands, to receive driving information of an ego vehicle and the target. The at least one processor is further configured to determine whether the target is driving relative to a path of the ego vehicle based on the driving information of the ego vehicle and the target. The at least one processor is further configured to calculate or determine a turning radius of the ego vehicle based on the driving information of the ego vehicle. The at least one processor is further configured to calculate or determine a turning radius of the target based on the turning radius of the ego vehicle. The at least one processor is further configured to generate a yaw rate profile of the target based on the turning radius of the target. The at least one processor is further configured to predict a path of the target based on the yaw rate profile of the target.

According to an embodiment of the present disclosure, it is possible to improve path prediction accuracy by predicting the driving path of a target based on driving information of an ego vehicle, even when map information and lane information are not available when predicting the path of the target.

According to an embodiment of the present disclosure, it is possible to improve the accuracy of a target's yaw rate value, by estimating the target's turning radius using the turning radius of an ego vehicle.

The present disclosure aims to provide a method and an apparatus capable of improving the performance of collision avoidance decision of an autonomous vehicle by providing an autonomous driving system with information on whether a target overlaps with a driving path of an ego vehicle.

The advantageous effects of the present disclosure are not limited to those described above; other advantageous effects of the present disclosure not mentioned above may be understood clearly by those having ordinary skill in the art from the present disclosure.

### BRIEF DESCRIPTION OF THE DRAWINGS

FIG. 1 is a block diagram schematically showing a path generating device according to an embodiment of the present disclosure.

FIG. 2 is a flowchart schematically illustrating a process in which the path generating device according to an embodiment of the present disclosure generates a predicted path of a target.

FIG. 3 is a diagram for explaining an example of a method in which the path generating device determines whether the target follows a path that is identical or similar to the driving path of an ego vehicle.

FIG. 4 is a diagram showing an example of a weight w determined based on the forward velocity of a vehicle.

FIG. 5 is a diagram for explaining an example of a method in which the path generating device calculates a target's turning radius.

FIG. 6 is a diagram for explaining an example of a method in which the path generating device calculates the target's turning radius in a situation where the ego vehicle is driving at a low curvature.

FIG. 7 is a flowchart illustrating a process in which the path generating device according to an embodiment of the present disclosure generates the predicted path of the target based on a yaw rate profile, a velocity profile, and a current position of the target.

FIG. 8 is a diagram for explaining an example of a situation in which the target overlaps with a driving area of the ego vehicle.

FIG. 9 is a diagram for explaining an example of a situation in which the target does not overlap with the driving area of the ego vehicle.

FIG. 10 is a block diagram schematically illustrating a computing device that may be used to implement a method or apparatus according to the present disclosure.

### DETAILED DESCRIPTION

Hereinafter, some embodiments of the present disclosure are described in detail with reference to the accompanying drawings. In the present disclosure, like reference numerals designate like elements, although the elements are shown in different drawings. Further, in the present disclosure, a detailed description of known functions and configurations incorporated therein has been omitted for the purpose of clarity and for brevity.

Additionally, various terms, such as first, second, A, B, (a), (b), etc., are used solely to differentiate one component from the other but are not intended to imply or suggest the substances, order, or sequence of the components. Throughout the present disclosure, when a part ‘includes’ or ‘comprises’ a component, the part is meant to further include other components and is not intended to exclude thereof unless specifically stated to the contrary. The terms such as ‘unit’, ‘module’, and the like refer to one or more units for processing at least one function or operation, which may be implemented by hardware, software, or a combination thereof. When a controller, unit, module, component, device, element, or the like of the present disclosure is described as having a purpose or performing an operation, function, or the like, the controller, unit, module, component, device, element, or the like should be considered herein as being “configured to” meet that purpose or to perform that operation or function. Each controller, unit, module, component, device, element, and the like may separately embody or be included with a processor and a memory, such as a non-transitory computer readable media, as part of the apparatus.

The following detailed description, together with the accompanying drawings, is intended to describe embodiments of the present disclosure and is not intended to represent the only embodiments in which the present disclosure may be practiced.

In the present disclosure, path prediction refers to the function of an autonomous driving system to predict the future path of a target (an object existing around an ego vehicle).

In the present disclosure, a prediction time window refers to a time window from a current time, at which the autonomous driving system attempts to predict the path, to a future time. The length of the prediction time window may be expressed in the unit of time. For example, if the autonomous driving system predicts a path from a current time to a future time 4 seconds later, the length of the prediction time window is 4 seconds.

In the present disclosure, a prediction time interval refers to a time interval during which the autonomous driving system predicts a path. The prediction time interval may be expressed in the unit of time. For example, if the autonomous driving system predicts the path in 0.1-second intervals, the prediction time interval is 0.1 seconds.

In the present disclosure, an ego coordinate is a Cartesian coordinate in which the origin is located at the front of the ego vehicle, the x-axis is parallel to the travel direction of the ego vehicle, and the y-axis is perpendicular to the travel direction of the ego vehicle.

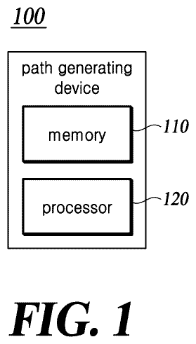

FIG. 1 is a block diagram schematically showing a path generating device 100 according to an embodiment of the present disclosure.

The path generating device 100 includes a memory 110 and a processor 120. The path generating device 100 may be implemented in the form of an embedded device, a server, an electronic device within an autonomous driving system, etc. Not all blocks illustrated in FIG. 1 are essential components, and some blocks included in the path generating device 100 may be added, changed, or deleted in other embodiments. The components illustrated in FIG. 1 represent functionally distinct elements, and one or more components may be implemented to be integrated with each other in an actual physical environment.

The memory 110 stores data and commands required for the operation of the path generating device 100.

The memory 110 may store driving information of the ego vehicle acquired using at least one sensor included in the ego vehicle. The driving information of the ego vehicle may include the velocity, acceleration, steering angle, yaw rate, etc. of the ego vehicle.

Further, the memory 110 may store driving information of the target acquired using at least one sensor included in the ego vehicle. The driving information of the target may include the position, velocity, heading angle, etc. of the target. In particular, each of the position, velocity, and heading angle of the target may be a relative position, a relative velocity, and a relative heading angle with respect to the ego vehicle.

The processor 120 controls the overall operation of the path generating device 100. The processor 120 may be implemented with one or more processors. The processor 120 may execute commands stored in the memory 110.

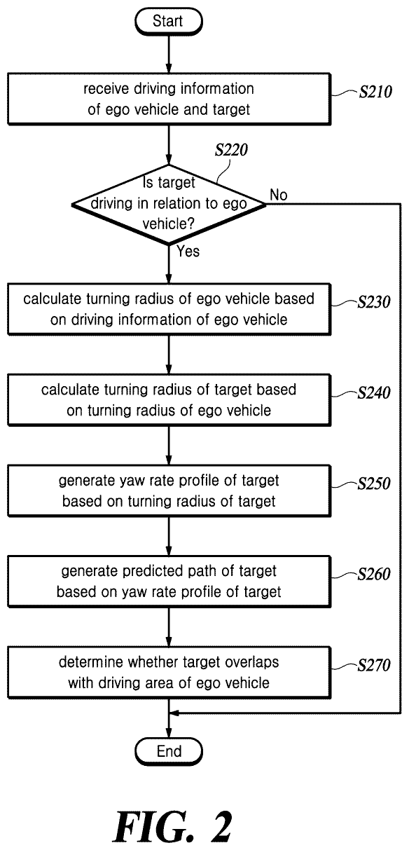

FIG. 2 is a flowchart schematically illustrating a process in which the path generating device 100 according to an embodiment of the present disclosure generates the predicted path of the target.

The path generating device 100 receives the driving information of the ego vehicle and the driving information of the target, in step S210.

The path generating device 100 determines whether the target is driving relative to the driving path of the ego vehicle, in step S220. If the target is not driving relative to the driving path of the ego vehicle (S220—NO), the path generating device 100 terminates the path prediction according to the present disclosure.

If the target is driving relative to the driving path of the ego vehicle (S220—YES), the path generating device 100 calculates the turning radius of the ego vehicle based on the driving information of the ego vehicle in step S230 and calculates the turning radius of the target based on the turning radius of the ego vehicle in step S240. The path generating device 100 generates the yaw rate profile of the target based on the target's turning radius in step S250 and generates the predicted path of the target based on the target's yaw rate profile in step S260. Further, the path generating device 100 determines whether the target overlaps with the driving area of the ego vehicle based on the predicted path of the ego vehicle and the predicted path of the target, in step S270.

Hereinafter, steps S220 to S270 are described in detail.

The path generating device 100 determines whether the target is driving relative to the driving path of the ego vehicle in step S220. In the present disclosure, the expression “the target is driving relative to the driving path of the ego vehicle” means that the target drives in the same direction as the ego vehicle along a path that is identical or similar to the driving path of the ego vehicle.

The path generating device 100 may determine that the target is driving relative to the driving path of the ego vehicle if all or some of first, second, and third conditions described below are satisfied.

The first condition is that the target follows a path that is identical or similar to the driving path of the ego vehicle.

The path generating device 100 may determine that the target satisfies the first condition if, for a predetermined tracking age or longer, a change amount ΔD_{Lat} of a relative lateral distance D_{Lat} between the ego vehicle and the target is equal to or less than a predetermined value and/or a change amount Δθ_{tgt} of a relative heading angle θ_{tgt} of the target is equal to or less than a predetermined value. In this example, the tracking age refers to time length for which the sensor continuously recognizes the target, the relative lateral distance refers to the shortest distance from the turning path of the ego vehicle to the target, calculated based on the steering angle and yaw rate of the ego vehicle, and the relative heading angle refers to a difference between the heading angle of the target and the heading angle of the ego vehicle.

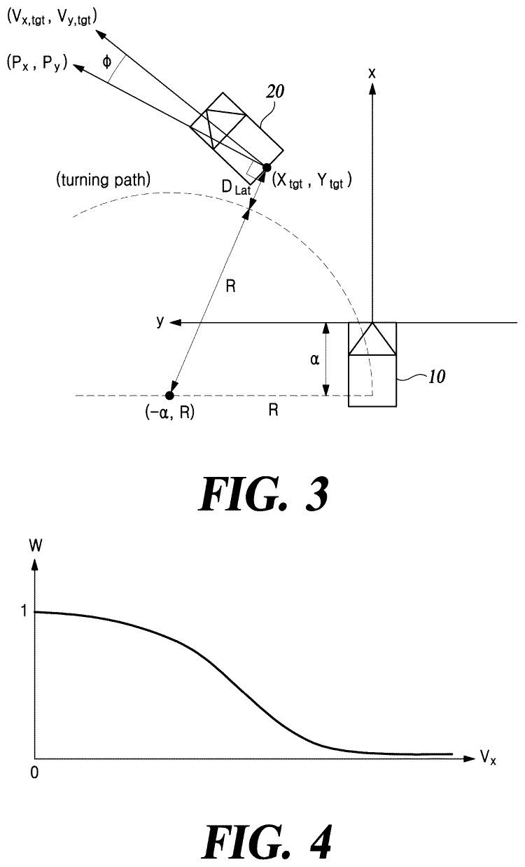

FIG. 3 is a diagram for explaining an example of a method in which the path generating device 100 determines whether the target follows a path that is identical or similar to the driving path of an ego vehicle.

In FIG. 3, (X_{tgt}, Y_{tgt}) are coordinate values indicating the position of the target 20 in the ego coordinate, and (−α, R) are coordinate values indicating the center of the turning path of the ego vehicle 10 calculated based on the steering angle and yaw rate of the ego vehicle 10. α is a distance from the front bumper of the ego vehicle 10 to a rear axle of the ego vehicle 10, and R is the turning radius of the turning path. D_{Lat} represents the shortest distance from the turning path of the ego vehicle 10 to the target 20.

Using well-known geometric principles, the relative lateral distance D_{Lat} may be calculated as shown in Equation 1.

$${D}_{Lat} = \sqrt{{( {X}_{tgt} + α )}^{2} + {( R - {Y}_{tgt} )}^{2}} - R \qquad [ Equation 1 ]$$

The path generating device 100 may calculate a relative lateral distance change amount ΔD_{Lat} from a difference between a relative lateral distance D_{Lat,cur} at a current time point and a relative lateral distance D_{Lat,pre} at a previous time point.

Further, the path generating device 100 may calculate a relative heading angle change amount Δθ_{tgt} from a difference between a relative heading angle θ_{tgt,cur} at the current time point received from one or more sensors and a relative heading angle θ_{tgt,pre} at the previous time point.

In additional embodiments, a noise removal filter may be used to minimize the effects of noise included in change amount calculation results. For example, the path generating device 100 may perform low-pass filtering or moving average filtering on the relative lateral distance change amount D_{Lat,cur}−D_{Lat,pre} and/or the relative heading angle change amount θ_{tgt,cur}−θ_{tgt,pre}.

The path generating device 100 may determine that the target 20 is following a path that is identical to or similar to the driving path of the ego vehicle 10, if the tracking age for the target is equal to or greater than a predetermined value and the relative lateral distance change amount ΔD_{Lat} and/or the relative heading angle change amount Δθ_{tgt} are equal to or less than each predetermined value.

The second condition is that the target is driving at a predetermined velocity or higher.

The path generating device 100 may determine that the target satisfies the second condition if the absolute speed of the target is equal to or greater than a predetermined value. The path generating device 100 may obtain the absolute speed of the target by adding the velocity of the ego vehicle to the relative velocity of the target received from one or more sensors to calculate the absolute velocity of the target and calculating the magnitude of the absolute speed of the target.

The third condition is that the target is driving in the same or similar direction as the travel direction of the ego vehicle.

The path generating device 100 may determine that the target satisfies the third condition if a difference between the direction of the target's relative velocity and the direction of the ego vehicle's turning path falls within a predetermined range. For example, referring to FIG. 3, if an angle φ between vector (V_{x, tgt}, V_{y, tgt}) representing the relative velocity of the target 20 and vector (Pₓ, P_{y}) which is perpendicular to a straight line passing through the center (−α, R) of the turning path of the ego vehicle 10 and the current position (X_{tgt}, Y_{tgt}) of the target 20 and has the same direction as that of the turning path falls within a predetermined range, the path generating device 100 may determine that the target 20 is driving in the same or similar direction as the direction in which the ego vehicle 10 is moving.

The path generating device 100 may calculate the turning radius of the ego vehicle's path based on the driving information of the ego vehicle, in step S230. More specifically, the path generating device 100 may calculate the turning radius of the ego vehicle path in a geometry-based method and/or a yaw rate-based method

The geometry-based method uses the vehicle's wheelbase and steering angle to calculate the turning radius of the turning path. Equation 2 is an equation for calculating the turning radius of the turning path in the geometry-based method.

$${R}_{g e o} = \frac{L}{tan δ} \qquad [ Equation 2 ]$$

In Equation 2, R_{geo} is the turning radius of the vehicle, L is the wheelbase of the vehicle, and δ is the steering angle of the vehicle.

The yaw rate-based method uses the vehicle's forward velocity and yaw rate to calculate the turning radius of the turning path. Equation 3 is an equation for calculating the turning radius of the turning path in the yaw rate-based method.

$${R}_{y a w} = \frac{{V}_{x}}{γ} \qquad [ Equation 3 ]$$

In Equation 3, R_{yaw} is the turning radius of the vehicle, Vₓ is the forward velocity of the vehicle, and γ is the yaw rate of the vehicle.

If the vehicle is driving at low speed, the accuracy of the turning radius calculated using the geometry-based method is high. If the vehicle is driving at high speed, the accuracy of the turning radius calculated using the yaw rate-based method is high. Therefore, the path generating device 100 may calculate the turning radius of the ego vehicle 10 as a weighted sum of R_{geo} and R_{yaw}. Equation 4 is an equation for calculating the turning radius of the ego vehicle 10 as the weighted sum.

$${R}_{e g o} = w \cdot {R}_{g e o} + ( 1 - w ) \cdot {R}_{y a w} \qquad [ Equation 4 ]$$

In Equation 4, R_{ego} is the turning radius of the ego vehicle 10, and w is a weight. The weight w has a value close to 1 if the ego vehicle 10 is driving at low speed, and a value close to 0 if the ego vehicle 10 is driving at high speed. The weight w may be determined based on a lookup table that takes the vehicle velocity as input.

FIG. 4 is a diagram showing an example of the weight w determined based on the forward velocity of the vehicle. In FIG. 4, if the forward velocity Vₓ of the vehicle is 0, the weight w is 1. If the forward velocity Vₓ of the vehicle is small, the weight w has a value close to 1. As the forward velocity Vₓ of the vehicle increases, the weight w approaches 0.

The path generating device 100 calculates the turning radius of the target using the turning radius of the ego vehicle, in step S240. The path generating device 100 calculates the target's turning radius based on the assumption that the center point of the target's turning path is the same as the center point of the ego vehicle's turning path relative to the ego vehicle's path.

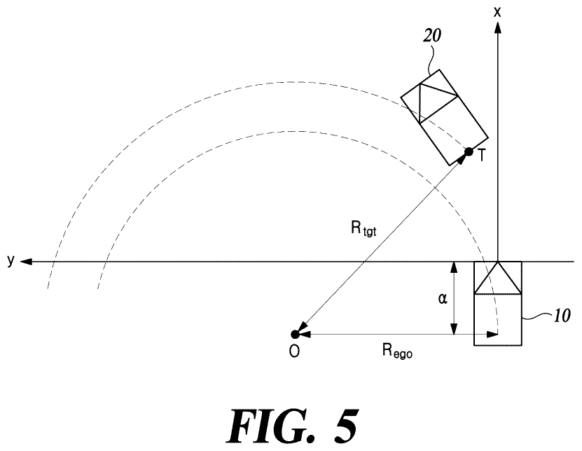

FIG. 5 is a diagram for explaining an example of a method in which the path generating device 100 calculates the target's turning radius.

In FIG. 5, T is the current position of the target 20 in the ego coordinate, and O is the center point of the turning path of the ego vehicle 10. α is the distance from the front bumper of the ego vehicle 10 to the rear axle of the ego vehicle 10, R_{ego} is the turning radius of the turning path of the ego vehicle 10, and R_{tgt} is the turning radius of the turning path of the ego vehicle 10.

Since it is assumed that the center point O of the turning path of the ego vehicle 10 and the center point O of the turning path of the target 20 are the same, the path generating device 100 may calculate the turning radius R_{tgt} of the target 20 by calculating a distance between the center point O of the turning path and the current position T of the target 20. Equation 5 is an equation for calculating the turning radius R_{tgt} of the target 20.

$${R}_{tgt} = sign ( {R}_{e g o} ) \cdot \sqrt{{( {X}_{tgt} + α )}^{2} + {( {Y}_{tgt} - {R}_{e g o} )}^{2}} \qquad [ Equation 5 ]$$

In Equation 5, sign(R_{ego}) represents the sign of the turning radius R_{ego} of the turning path of the ego vehicle 10, (X_{tgt}, Y_{tgt}) is a coordinate value representing the current position T of the target 20, and (−α, R_{ego}) is a coordinate value representing the center point O of the turning path of the ego vehicle 10 and the target 20.

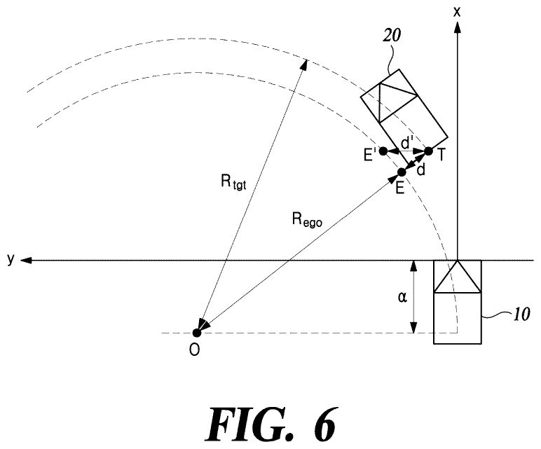

FIG. 6 is a diagram for explaining an example of a method in which the path generating device 100 calculates the target's turning radius in a situation where the ego vehicle is driving at a low curvature.

In FIG. 6, T is the current position of the target 20 in the ego coordinate, and O is the center point of the turning path of the ego vehicle 10. α is the distance from the front bumper of the ego vehicle 10 to the rear axle of the ego vehicle 10, R_{ego} is the turning radius of the turning path of the ego vehicle 10, and R_{tgt} is the turning radius of the turning path of the ego vehicle 10.

Further, in FIG. 6, E is a point where a straight line connecting T and O intersects with the turning path of the ego vehicle 10, d is a distance between T and E, E′ is a point where a straight line parallel to the y-axis of the ego coordinate while passing through T intersects with the turning path of the ego vehicle 10, and d′ is a distance between T and E′.

If the turning radius R_{ego} of the turning path of the ego vehicle 10 is long, i.e., if the turning path of the ego vehicle 10 has a low curvature, the length of d approaches the length of d′. Therefore, the path generating device 100 may calculate the turning radius R_{tgt} of the target 20 by adding d′ to the turning radius R_{ego} of the ego vehicle 10. Equation 6 is an equation for calculating the turning radius R_{tgt} of the target 20 in a situation where the ego vehicle 10 is driving at a low curvature.

$${R}_{tgt} = {R}_{e g o} + {d}^{′} = {R}_{e g o} + {Y}_{{E}^{′}} - {Y}_{tgt} \qquad [ Equation 6 ]$$

In Equation 6, Y_{E′} is the y-axis coordinate value of E′, and Y_{tgt} is the y coordinate value of T. Equation 7 is an equation that shows the process of deriving Y_{E′} of Equation 6.

$$\begin{matrix}{( {R}_{e g o} )}^{2} = {( {X}_{{E}^{′}} + α )}^{2} + {( {Y}_{{E}^{′}} - {R}_{e g o} )}^{2} \\ {( {X}_{tgt} + α )}^{2} + {Y}_{{E}^{′}}^{2} - 2 {R}_{e g o} {Y}_{{E}^{′}} + {( {R}_{e g o} )}^{2} \\ \to 0 = {( {X}_{tgt} + α )}^{2} + {Y}_{{E}^{′}}^{2} - 2 {R}_{e g o} {Y}_{{E}^{′}} \\ \approx {( {X}_{tgt} + α )}^{2} - 2 {R}_{e g o} {Y}_{{E}^{′}} \\ ∴ {Y}_{{E}^{′}} = \frac{{( {X}_{tgt} + α )}^{2}}{2 {R}_{e g o}}\end{matrix} \qquad [ Equation 7 ]$$

In Equation 7, it is assumed that X_{E′} is the x-axis coordinate value of E′, X_{tgt} is the x-axis coordinate value of T, and Y_{E′} is a much smaller value than R_{ego} and X_{tgt}.

In an embodiment, the path generating device 100 may calculate the turning radius R_{tgt} of the target 20 using the method of FIG. 5 in a situation where the ego vehicle 10 is driving at a high curvature. The path generating device 100 may calculate the turning radius R_{tgt} of the target 20 using the method of FIG. 6 in a situation where the ego vehicle 10 is driving at a low curvature.

In a situation where the ego vehicle 10 is driving at the low curvature, a square root operation may be eliminated by calculating an approximate value for the turning radius of the target 20. In general, the square root operation is slow, so eliminating the square root operation can reduce an operation amount and improve operation speed.

The path generating device 100 generates the yaw rate profile of the target 20 using the turning radius R_{tgt} of the target 20 and the velocity profile of the target 20, in step S250. The yaw rate profile refers to a sequence of yaw rate values representing yaw rate values at each time points within the prediction time window, and the velocity profile refers to a sequence of velocity values representing velocity values at each time points within the prediction time window. For example, if the prediction time window is 4 seconds and the time interval is 0.1 seconds, the velocity profile contains 41 (=4 s/0.1 s+1) velocity values predicted at 0.1 second intervals. In this disclosure, it is assumed that the velocity profile of the target 20 reflecting the acceleration and deceleration of the target 20 has already been generated.

Equation 8 is an equation that generates the yaw rate profile of the target 20 using the turning radius R_{tgt} of the target 20 and the velocity profile of the target 20.

$${γ}_{tgt , t} = \frac{{V}_{tgt , t}}{{R}_{tgt}} \qquad [ Equation 8 ]$$

In Equation 8, γ_{tgt,t} is the yaw rate of the target 20 at time t, V_{tgt,t} is the velocity of the target 20 at time t stored in the velocity profile of the target 20, and R_{tgt} is the turning radius of the target 20. The yaw rate of the target 20 and the velocity of the target 20 may be a ground yaw rate and a ground velocity based on the ground, respectively.

The path generating device 100 predicts the path of the target 20 based on the yaw rate profile, velocity profile, and relative position of the target 20, in step S260.

In the present disclosure, the predicted path of the target 20 may be expressed as a point set, which is a sequence of points that include the position information and direction information of the target 20 at each time points. The size of the point set (the number of elements in the point set) is determined based on the length of the prediction time window and the length of the prediction time interval. For example, if the length of the prediction time window is 4 seconds and the length of the prediction time interval is 0.1 seconds, the point set contains 41 points (=4 s/0.1 s+1). Each point (element) included in the point set represents the target's position and direction information at each time points. For example, each point may be represented as X_{tgt,t}, Y_{tgt,t}, and θ_{tgt,t}. In this example, X_{tgt,t} and Y_{tgt,t} are the target positions at time t seconds later in the ego coordinate at the current time, and θ_{tgt,t} is the target heading angle at time t seconds later in the ego coordinate at the current time.

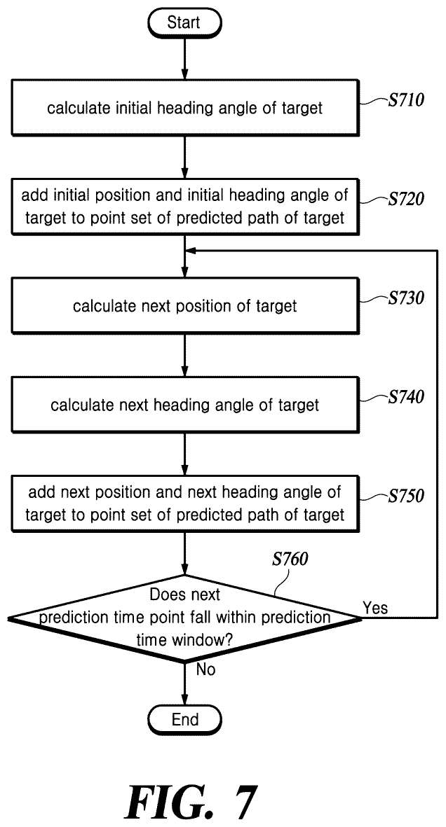

FIG. 7 is a flowchart illustrating a process in which the path generating device 100 according to an embodiment of the present disclosure generates the predicted path of the target 20 based on the yaw rate profile, velocity profile, and current position of the target 20.

The path generating device 100 calculates an initial heading angle θ_{tgt,0} of the target 20, in step S710. In order for the target 20 to follow a turning path according to the current driving radius of the target 20, the initial heading angle θ_{tgt,0} of the target 20 is set to match the tangent direction of a driving circle according to the current driving radius of the target 20. Equation 9 is an equation for calculating the initial heading angle θ_{tgt,0} of the target 20.

$$[ Equation 9 ]$$

$${θ}_{tgt , 0} = \{ \begin{matrix}π - a tan 2 ( {X}_{tgt , 0} + α , {Y}_{tgt , 0} - {R}_{ego} ) , & {R}_{ego} \geq 0 and {X}_{tgt , 0} + α \geq 0 \\ - π - a tan 2 ( {X}_{tgt , 0} + α , {Y}_{tgt , 0} - {R}_{ego} ) , & {R}_{ego} \geq 0 and {X}_{tgt , 0} + α < 0 \\ - a tan 2 ( {X}_{tgt , 0} + α , {Y}_{tgt , 0} - {R}_{ego} ) , & {R}_{ego} < 0\end{matrix}$$

In Equation 9, the case of R_{ego}≥0 represents a situation in which the ego vehicle 10 turns left, and the case of R_{ego}<0 represents a situation in which the ego vehicle 10 turns right.

The path generating device 100 adds a point representing the initial position X_{tgt,0}, Y_{tgt,0} of the target 20 received from one or more sensors attached to the ego vehicle 10 and the initial heading angle θ_{tgt,0} of the target 20 calculated using Equation 9 to the predicted path point set of the target 20, in step S720.

The path generating device 100 calculates the position of the target 20 at a next time point based on the position, heading angle, and velocity profile of the target 20 at the previous time point, in step S730. Equation 10 is an equation for calculating a next position of the target 20.

$$\{ \begin{matrix}{X}_{tgt , t} = {X}_{tgt , t - 1} + \vert {V}_{tgt , t - 1} \vert \cdot Δ t \cdot cos {θ}_{tgt , t - 1} \\ {Y}_{tgt , t} = {Y}_{tgt , t - 1} + \vert {V}_{tgt , t - 1} \vert \cdot Δ t \cdot sin {θ}_{tgt , t - 1}\end{matrix} \qquad [ Equation 10 ]$$

In Equation 10, X_{tgt,t}, Y_{tgt,t} represent the position of the target 20 at time t, |V_{tgt,t}| represents the speed of the target 20 at time t, θ_{tgt,t} represents the heading angle of the target 20 at time t, and Δt is the size of the prediction time interval.

The path generating device 100 calculates the heading angle of the target 20 at the next time point based on the heading angle and yaw rate profile of the target 20 at the previous time point, in step S740. Equation 11 is an equation for calculating a next heading angle of the target 20.

$${θ}_{tgt , t} = {θ}_{tgt , t - 1} + {γ}_{tgt , t - 1} \cdot Δ t \qquad [ Equation 11 ]$$

In Equation 11, θ_{tgt,t} represents the heading angle of the target 20 at time t, γ_{tgt,t} represents the yaw rate of the target 20 at time t, and Δt represents the size of the prediction time interval.

The path generating device 100 adds a point representing the updated position X_{tgt,t}, Y_{tgt,t} and updated heading angle θ_{tgt,t} of the target 20 to the predicted path point set of the target 20, in step S750.

The path generating device 100 determines whether a next prediction time t+1 is included in the prediction time window, in step S760. If the next prediction time t+1 is included in the prediction time window (S760—YES), the path generating device 100 repeats steps S730 to S750 for the next prediction time point. If the next prediction time t+1 is not included in the prediction time window (S760—NO), the path generating device 100 terminates the path prediction process for the target 20.

In addition, the path generating device 100 may determine whether the target overlaps with the driving area of the ego vehicle 10 based on the predicted path of the ego vehicle 10 and the predicted path of the target 20, in step S270. In an embodiment, the predicted path of the ego vehicle 10 may be expressed as a point set, which is a sequence of points that include position information and direction information of the ego vehicle 10 at each time points, like the predicted path of the target 20.

The path generating device 100 may determine whether the target 20 overlaps with the driving area of the ego vehicle 10 based on a width of each of the ego vehicle 10 and the target 20 and a distance between the predicted paths of the ego vehicle 10 and the target 20. Equation 12 is an equation for determining whether the target 20 overlaps with the driving area of the ego vehicle 10.

$${D}_{o} < \frac{{W}_{e g o}}{2} + \frac{{W}_{tgt}}{2} \qquad [ Equation 12 ]$$

In Equation 12, Do is a distance from a point on the predicted path of the target 20 to the driving path of the ego vehicle 10, calculated in the direction perpendicular to the predicted path of the target 20, W_{ego} is the width of the ego vehicle 10, and W_{tgt} is the width of the target 20.

The path generating device 100 may determine that the target 20 is overlapping with the driving area of the ego vehicle 10 within the prediction time window if the inequality of Equation 12 is satisfied at a point on the predicted path of the target 20. On the other hand, if the inequality of Equation 12 is not satisfied, the path generating device 100 may determine that the target 20 does not overlap with the driving area of the ego vehicle 10 within the prediction time window.

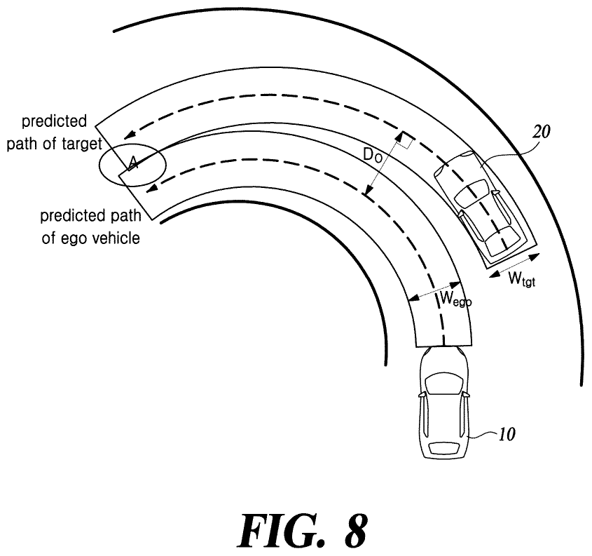

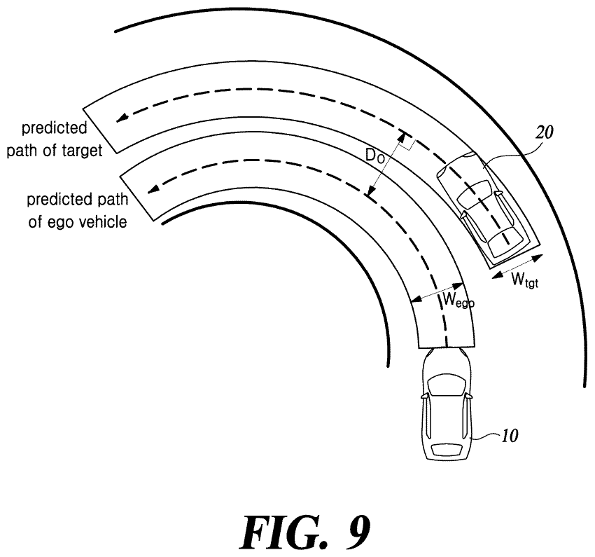

FIG. 8 is a diagram for explaining an example of a situation in which the target 20 overlaps with the driving area of the ego vehicle 10. FIG. 9 is a diagram for explaining an example of a situation in which the target 20 does not overlap with the driving area of the ego vehicle 10.

In FIG. 8 and FIG. 9, the broken line indicates the predicted path of the ego vehicle 10 and the predicted path of the target 20, and a gray area extending along the broken line indicates the driving area of the ego vehicle 10 and the driving area of the target 20. The width of the driving area of the ego vehicle 10 is equal to the width W_{ego} of the ego vehicle 10, and the width of the driving area of the target 20 is equal to the width W_{tgt} of the target 20.

Referring to FIG. 8, the path generating device 100 may determine that the target 20 is overlapping with the driving area of the ego vehicle 10 near the last time (area A) of the prediction time window. On the other hand, referring to FIG. 9, the path generating device 100 may determine that the target 20 does not overlap with the driving area of the ego vehicle 10 within the prediction time window.

If information is generated (output) on whether the target 20 driving relative to the path of the ego vehicle 10 overlaps with the driving area of the ego vehicle 10, the autonomous driving system may use the information when determining a collision between the ego vehicle 10 and the target 20. Thus, the collision decision performance of the autonomous vehicle can be improved when the ego car and the target are turning (e.g., roundabouts, high-curvature ramps) in a situation where map information and lane information are unavailable (e.g., past map information, rainy environments where it is difficult for the sensor to recognize lanes, etc.).

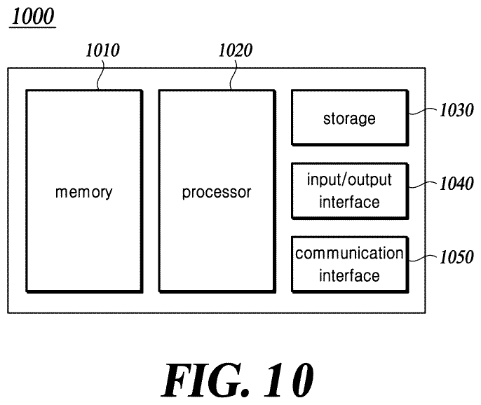

FIG. 10 is a block diagram schematically illustrating a computing device that may be used to implement a method or apparatus according to the present disclosure.

The computing device 1000 may include some or all of a memory 1010, a processor 1020, a storage 1030, an input/output interface 1040, and a communication interface 1050. The computing device 1000 may structurally and/or functionally include at least a portion of the apparatus according to the present disclosure. The computing device 1000 may be a stationary computing device such as a desktop computer or a server as well as a mobile computing device, such as a laptop computer, a smart phone, or a vehicle electronic component. The computing device 1000 may be implemented as any specialized hardware accelerator capable of processing operations for an artificial intelligence model in an efficient manner. For example, the computing device 1000 may include a graphic processing unit (GPU), a tensor processing unit (TPU), or a neural processing unit (NPU).

The memory 1010 may store a program that causes the processor 1020 to perform methods or operations according to various embodiments of the present disclosure. For example, the program may include a plurality of instructions executable by the processor 1020, and the above-described method or operations may be performed by executing the plurality of instructions through the processor 1020. The memory 1010 may be a single memory or multiple memories. In this case, information required to perform the method or operation according to various embodiments of the present disclosure may be stored in the single memory or divided and stored in the multiple memories. When the memory 1010 comprises multiple memories, the multiple memories may be physically separated. The memory 1010 may include at least one of volatile memory or non-volatile memory. The volatile memory includes SRAM (Static Random Access Memory) or DRAM (Dynamic Random Access Memory), and the nonvolatile memory includes flash memory.

The processor 1020 may include at least one core capable of executing at least one instruction. The processor 1020 may execute instructions stored in the memory 1010. The processor 1020 may be a single processor or multiple processors.

The storage 1030 maintains stored data even when power supplied to the computing device 1000 is cut off. For example, the storage 1030 may include the non-volatile memory and may include storage media, such as magnetic tape, optical disks, or magnetic disks. A program stored in the storage 1030 may be loaded into the memory 1010 before being executed by the processor 1020. The storage 1030 may store a file written in a programming language, and a program generated from the file by a compiler or the like may be loaded into the memory 1010. The storage 1030 may store data to be processed by the processor 1020 and/or data processed by the processor 1020.

The input/output interface 1040 may provide an interface with an input device such as a keyboard or a mouse, and/or an output device such as a display device or a printer. A user may trigger execution of a program by the processor 1020 through the input device and/or check the processing result of the processor 1020 through the output device.

The communication interface 1050 may provide access to an external network. The computing device 1000 may communicate with other devices through the communication interface 1050.

Each element of the apparatus or method in accordance with the present disclosure may be implemented in hardware, software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present disclosure as being sequentially performed, this is merely a description of the technical idea of some embodiments of the present disclosure. In other words, those having ordinary skill in the art to which the present disclosure belongs may appreciate that various modifications and changes can be made without departing from essential features of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present disclosure is not limited by the illustrations. Accordingly, those of ordinary skill in the art should understand that the scope of the present disclosure should not be limited by the above explicitly described embodiments but by the claims and equivalents thereof.

What is claimed is:

1. A method for predicting a driving path of a target, the method comprising:
receiving driving information of an ego vehicle and the target;
determining whether the target is driving relative to a path of the ego vehicle, based on the driving information of the ego vehicle and the target;
determining a turning radius of the ego vehicle based on the driving information of the ego vehicle;
determining a turning radius of the target based on the turning radius of the ego vehicle;
generating a yaw rate profile of the target based on the turning radius of the target; and
predicting a path of the target based on the yaw rate profile of the target.

2. The method of claim 1, wherein determining whether the target is driving relative to the path of the ego vehicle comprises:
determining whether the target is driving;
determining whether the target is driving along the path of the ego vehicle; and
determining whether the target is driving in a driving direction of the ego vehicle.

3. The method of claim 2, wherein determining whether the target is driving comprises determining whether a velocity of the target is equal to or greater than a first predetermined value.

4. The method of claim 2, wherein determining whether the target is driving along the path of the ego vehicle comprises:
determining whether a change amount in lateral distance between the target and the ego vehicle is equal to or less than a second predetermined value; and
determining whether a change amount in heading angle of the target is equal to or less than a third predetermined value,
wherein the lateral distance between the target and the ego vehicle is a shortest distance from a turning path of the ego vehicle to the target, and
wherein the turning path of the ego vehicle is calculated based on the driving information of the ego vehicle.

5. The method of claim 2, wherein determining whether the target is driving in the driving direction of the ego vehicle comprises determining whether a difference between the driving direction of the target and a travel direction of a turning path of the ego vehicle calculated based on the driving information of the ego vehicle is within a predetermined range.

6. The method of claim 1, wherein determining the turning radius of the ego vehicle comprises:
calculating a first turning radius based on a wheelbase and a steering angle of the ego vehicle;
calculating a second turning radius based on a forward velocity and a yaw rate of the ego vehicle; and
calculating the turning radius of the ego vehicle by weighted summing the first turning radius and the second turning radius.

7. The method of claim 6, wherein a weight of the first turning radius is inversely proportional to a speed of the ego vehicle, and
wherein a weight of the second turning radius is proportional to the speed of the ego vehicle.

8. The method of claim 1, wherein the turning radius of the target is a distance from a current position of the target to a center point of a driving circle according to the turning radius of the ego vehicle.

9. The method of claim 8, wherein, based on the turning radius of the ego vehicle being equal to or greater than a forth predetermined value, the turning radius of the target is a sum of the turning radius of the ego vehicle and a lateral distance from a current position of the target to the driving circle.

10. The method of claim 1, wherein generating the yaw rate profile of the target comprises generating a sequence of yaw rate values representing yaw rate values in a prediction time window of the target based on the turning radius and a velocity profile of the target.

11. The method of claim 1, wherein predicting the path of the target comprises:
(a) adding a point representing a position and heading angle of the target at a current time to a point set of path prediction of the target;
(b) calculating a position of the target at a next time point based on a previous point and a velocity profile of the target;
(c) calculating a heading angle of the target at the next time point based on the yaw rate profile of the target;
(d) adding a point representing the position and the heading angle of the target at the next time point to the point set of path prediction of the target; and
(e) repeating the steps (b), (c), and (d) for each of time points included in a prediction time window of the target.

12. The method of claim 1, further comprising:
determining whether a driving area of the target overlaps with a driving area of the ego vehicle,
wherein the driving area of the target is determined based on a width of the target and a predicted path of the target, and
wherein the driving area of the ego vehicle is determined based on a width of the ego vehicle and a predicted path of the ego vehicle.

13. The method of claim 12, wherein determining whether the driving area of the target overlaps with the driving area of the ego vehicle comprises determining whether a distance from any point on the predicted path of the target to the predicted path of the ego vehicle is less than a sum of the width of the target and the width of the ego vehicle.

14. An apparatus comprising:
at least one memory configured to store commands; and
at least one processor, by executing the commends, configured to:
receive driving information of an ego vehicle and a target;
determine whether the target is driving relative to a path of the ego vehicle based on the driving information of the ego vehicle and the target;
determine a turning radius of the ego vehicle based on the driving information of the ego vehicle;
determine a turning radius of the target based on the turning radius of the ego vehicle;
generate a yaw rate profile of the target based on the turning radius of the target; and
predict a path of the target based on the yaw rate profile of the target.
